(19) United States
(12) Patent Application Publication
(10) Pub. No.: US 2023/0417581 A1
(43) Pub. Date: Dec. 28, 2023

(54) INDUSTRIAL VEHICLE CONTROL DEVICE, INDUSTRIAL VEHICLE, AND INDUSTRIAL VEHICLE CONTROL PROGRAM

(71) Applicants: KABUSHIKI KAISHA TOYOTA JIDOSHOKKI, Kariya-shi (JP); NATIONAL INSTITUTE OF ADVANCED INDUSTRIAL SCIENCE AND TECHNOLOGY, Tokyo (JP)

(72) Inventors: Mitsuru KAWAMOTO, Tsukuba-shi (JP); Hironobu OKAMOTO, Tsukuba-shi (JP)

(73) Assignees: KABUSHIKI KAISHA TOYOTA JIDOSHOKKI, Kariya-shi (JP); NATIONAL INSTITUTE OF ADVANCED INDUSTRIAL SCIENCE AND TECHNOLOGY, Tokyo (JP)

(21) Appl. No.: 18/210,237

(22) Filed: Jun. 15, 2023

(30) Foreign Application Priority Data
Jun. 23, 2022 (JP) 2022-101153

(51) Int. Cl. G01D 21/02

(52) U.S. Cl. CPC G01D 21/02

(57) ABSTRACT

An industrial vehicle control device for controlling an industrial vehicle includes: a first signal acquisition unit that acquires a first signal; a second signal acquisition unit that acquires a second signal; a data processing unit that performs data processing based on time-series data of the first signal and the second signal; and a state estimation unit that estimates a state of the industrial vehicle by distinguishing results of the data processing.

### CROSS REFERENCE TO RELATED APPLICATIONS

This application claims priority to Japanese Patent Application No. 2022-101153 filed on Jun. 23, 2022, the entire contents of which are incorporated by reference herein.

### TECHNICAL FIELD

The present disclosure relates to an industrial vehicle control device, an industrial vehicle, and an industrial vehicle control program.

### BACKGROUND

As a conventional industrial vehicle control device, for example, a technique disclosed in Japanese Unexamined Patent Publication No. H5-24796 is known. The control device described in Japanese Unexamined Patent Publication No. H5-24796 is mounted in an industrial vehicle. The control device estimates the state of the industrial vehicle based on signals acquired by a plurality of sensors provided in the industrial vehicle.

### SUMMARY

Here, in order to more accurately estimate the state of the industrial vehicle, it is necessary to consider a plurality of signals. However, it is not possible to grasp whether or not the acquisition result is necessary for estimation simply by acquiring the signals. Therefore, it is required to improve the accuracy of estimating the state of the industrial vehicle by dividing the acquisition result of each signal into pieces of information necessary for estimation.

It is an object of the present disclosure to provide an industrial vehicle control device, an industrial vehicle, and an industrial vehicle control program capable of improving the accuracy of estimating the state of an industrial vehicle.

An industrial vehicle control device according to an aspect of the present disclosure is an industrial vehicle control device for controlling an industrial vehicle, and includes a first signal acquisition unit that acquires a first signal, a second signal acquisition unit that acquires a second signal, a data processing unit that performs data processing based on time-series data of the first signal and the second signal, and a state estimation unit that estimates a state of the industrial vehicle by distinguishing results of the data processing.

Since the industrial vehicle control device according to the aspect of the present disclosure acquires the first signal and the second signal, it is possible to accurately estimate the state of the industrial vehicle by using a plurality of signals rather than a single signal. Here, the data processing unit performs data processing based on the time-series data of the first signal and the second signal. Therefore, the data processing unit can perform data processing based on the time-series data of the first signal and the second signal so as to be suitable for estimating the state of the industrial vehicle. The state estimation unit can accurately estimate the state of the industrial vehicle by distinguishing the results of the data processing adjusted so that the state can be easily estimated as described above. As described above, it is possible to improve the accuracy of estimating the state of the industrial vehicle.

The first signal acquisition unit may acquire the first signal indicating a surrounding environment of the industrial vehicle, and the second signal acquisition unit may acquire the second signal indicating a state of the industrial vehicle itself. In this case, the state estimation unit can accurately estimate the state of the industrial vehicle by considering two aspects of the surrounding environment of the industrial vehicle and the state of the industrial vehicle itself.

The first signal acquisition unit may acquire sound data from a sound sensor as the first signal, the second signal acquisition unit may acquire acceleration data from an acceleration sensor provided in a cargo handling unit of the industrial vehicle as the second signal, and the state estimation unit may estimate a cargo handling state of the industrial vehicle. In this case, the state estimation unit can accurately estimate the state of the industrial vehicle by considering the sounds generated in the surroundings due to the operation and the like of the industrial vehicle and the acceleration due to the operation of the cargo handling unit or the traveling of the industrial vehicle.

The data processing unit may acquire the time-series data of sound data as the first signal and acceleration data as the second signal and extract a plurality of feature quantities based on different viewpoints from the time-series data at predetermined time intervals, and the state estimation unit may estimate the state by clustering extraction results of the feature quantities of the data processing unit. In this case, the data processing unit can extract a plurality of feature quantities at predetermined time intervals from data having different properties, such as sound data and acceleration data, so that the state of the industrial vehicle can be easily estimated. Then, the state estimation unit can cluster the extraction results into categories indicating a plurality of states of the industrial vehicle based on the tendency of the extracted feature quantities. Therefore, the state estimation unit can accurately estimate the state of the industrial vehicle.

An industrial vehicle according to another aspect of the present disclosure includes the industrial vehicle control device described above. This industrial vehicle can obtain the same functions and effects as those of the control device described above.

An industrial vehicle control program according to still another aspect of the present disclosure is an industrial vehicle control program for controlling an industrial vehicle, and causes a computer system to execute: a first signal acquisition step for acquiring a first signal; a second signal acquisition step for acquiring a second signal; a data processing step for performing data processing based on time-series data of the first signal and the second signal; and a state estimation step for estimating a state of the industrial vehicle by distinguishing results of the data processing.

This industrial vehicle control program can obtain the same functions and effects as those of the control device described above.

According to the present disclosure, it is possible to provide an industrial vehicle control device, an industrial vehicle, and an industrial vehicle control program capable of improving the accuracy of estimating the state of an industrial vehicle.

### BRIEF DESCRIPTION OF THE DRAWINGS

FIG. 1 is a side view of a reach-type forklift including a control device according to an embodiment of the present disclosure.

FIG. 2 is a block configuration diagram showing the control device shown in FIG. 1 and components related thereto.

FIGS. 3A, 3B and 3C are diagrams showing examples of the feature quantity of sound data.

FIG. 4 is a table showing an example of data-processed time-series data.

FIG. 5 is a table showing an example of a color scale conversion table.

FIG. 6 is a graph showing a feature quantity clustering result at each time.

FIG. 7 is a flowchart showing details of control by the control device.

### DETAILED DESCRIPTION

Hereinafter, an embodiment of the present disclosure will be described in detail with reference to the diagrams.

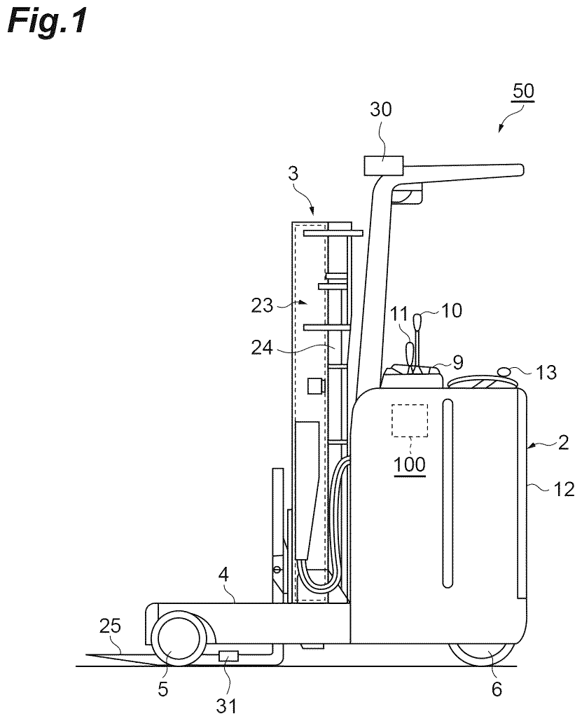

FIG. 1 is a side view of a reach-type forklift including a control device according to the present embodiment. In addition, in the following description, “left” and “right” will be used, but these correspond to “left” and “right” when viewed from the rear to the front. As shown in FIG. 1, a reach-type forklift (hereinafter, simply referred to as a forklift) 50 as an industrial vehicle is of a three-wheel vehicle type with two driven front wheels and one driving rear wheel, and is a battery vehicle that travels using a battery housed in the front portion of a vehicle (machine base) 2 as a power supply. The forklift 50 includes the vehicle 2 and a cargo handling device 3.

The vehicle 2 includes a pair of left and right reach legs 4 extending forward. Left and right front wheels 5 are rotatably supported by the left and right reach legs 4, respectively. A rear wheel 6 is one rear wheel, and is a driving wheel that also serves as a steering wheel. A rear portion of the vehicle 2 is a standing type driver's seat 12. A cargo handling lever 10 for a cargo handling operation and an accelerator lever 11 for forward and backward operations are provided in an instrument panel 9 on the front side of the driver's seat 12. In addition, a steering wheel 13 is provided on the upper surface of the instrument panel 9.

The cargo handling device 3 is provided on the front side of the vehicle 2. When a reach lever of the cargo handling lever 10 is operated, a reach cylinder is driven to extend and contract so that the cargo handling device 3 moves forward and backward along the reach legs 4 within a predetermined stroke range. In addition, the cargo handling device 3 includes a two-stage mast 23, a lift cylinder 24, a tilt cylinder, and a fork 25. When a lift lever of the cargo handling lever 10 is operated, the lift cylinder 24 is driven to extend and contract so that the mast 23 slidably extends and contracts in the vertical direction and the fork 25 moves up and down in conjunction with this.

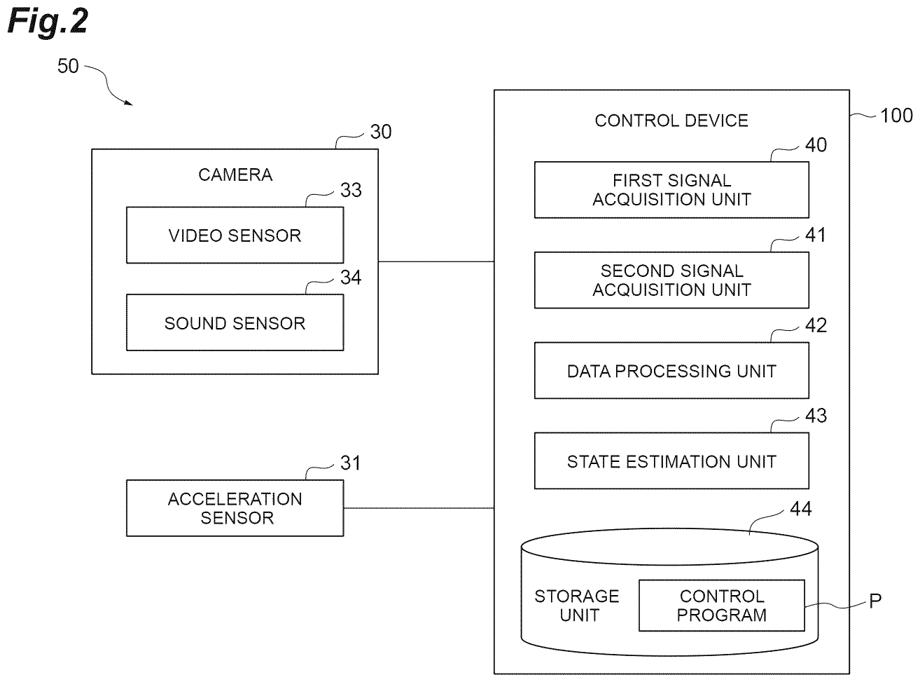

The forklift 50 includes a control device 100 according to the present embodiment in the vehicle 2. In addition, the forklift 50 has a camera 30 at a position where the surrounding environment of the forklift 50 can be easily imaged. The forklift 50 has an acceleration sensor 31 on the fork 25 (cargo handling unit). In addition, the positions of the camera 30 and the acceleration sensor 31 are not particularly limited, and the positions where the camera 30 and the acceleration sensor 31 are provided may be changed as appropriate. For example, the acceleration sensor 31 may be attached to a member that moves up and down together with the fork 25, such as a backrest. Next, the control device 100 of the forklift 50 according to the present embodiment will be described in further detail with reference to FIG. 2. FIG. 2 is a block configuration diagram showing the control device 100 according to the present embodiment and components related thereto. As shown in FIG. 2, the forklift 50 includes the camera 30, the acceleration sensor 31, and the control device 100.

The camera 30 is a device for acquiring images and sounds showing the surrounding environment of the forklift 50. The camera includes a video sensor 33 for acquiring video data and a sound sensor 34 for acquiring sound data. In addition, the camera 30 can acquire video data and sound data in time series. The camera 30 transmits the time-series video data and sound data to the control device 100.

The acceleration sensor 31 is a device for acquiring acceleration data, which is information indicating the state of the forklift 50 itself. Since the acceleration sensor 31 is provided on the fork 25 (see FIG. 1), it is possible to acquire acceleration data when the fork 25 moves up and down and stops in addition to acceleration data when the forklift 50 itself travels and stops. In addition, the acceleration sensor 31 can acquire acceleration data in time series. The acceleration sensor 31 transmits the time-series acceleration data to the control device 100.

The control device 100 is a device for controlling the forklift 50. The control device 100 includes an ECU [electronic control unit] for overall management of the device. The ECU is an electronic control unit including a CPU [central processing unit], a ROM [read only memory], a RAM [random access memory], a CAN [controller area network] communication circuit, and the like. The ECU realizes various functions, for example, by loading a program stored in the ROM into the RAM and executing the program loaded into the RAM by the CPU. The ECU may include a plurality of electronic units.

The control device 100 includes a first signal acquisition unit 40, a second signal acquisition unit 41, a data processing unit 42, a state estimation unit 43, and a storage unit 44.

The first signal acquisition unit 40 functions by executing a program stored in the storage unit 44 of the ECU by the CPU. The first signal acquisition unit 40 acquires sound data indicating the surrounding environment of the forklift 50 as a first signal. The first signal acquisition unit 40 acquires time-series sound data from the sound sensor 34 of the camera 30, and inputs into the ECU.

The second signal acquisition unit 41 functions by executing a program stored in the storage unit 44 of the ECU by the CPU. The second signal acquisition unit 41 acquires acceleration data indicating the state of the forklift 50 as a second signal, and inputs into the ECU. The second signal acquisition unit 41 acquires time-series acceleration data from the acceleration sensor 31. In addition, the acceleration data includes information regarding acceleration in each direction in a three-dimensional space. Specifically, the acceleration data includes information regarding acceleration in the X-axis direction, acceleration in the Y-axis direction, and acceleration in the Z-axis direction.

The data processing unit 42 functions by executing a program stored in the storage unit 44 of the ECU by the CPU. The data processing unit 42 performs data processing based on the first signal and the second signal. The data processing unit 42 acquires time-series data of sound data as a first signal and acceleration data as a second signal, and inputs into the ECU. Here, since the sound data and the acceleration data have different data acquisition cycles, data formats, and the like, it is difficult to simultaneously handle the time-series data of the sound and the time-series data of the acceleration as they are. Therefore, the data processing unit 42 extracts a plurality of feature quantities based on different viewpoints from the time-series data every predetermined time. The data processing unit 42 extracts a plurality of feature quantities by using time-series sound data for each predetermined time. In addition, the data processing unit 42 extracts a plurality of feature quantities by using time-series acceleration data for each predetermined time.

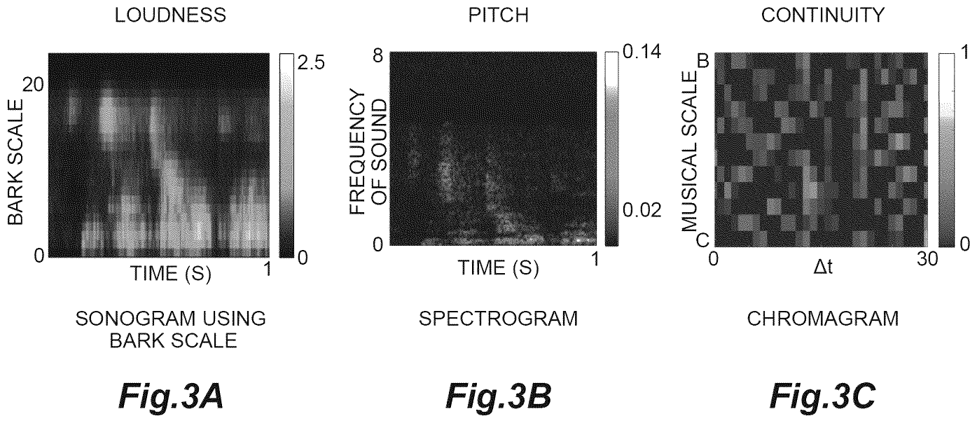

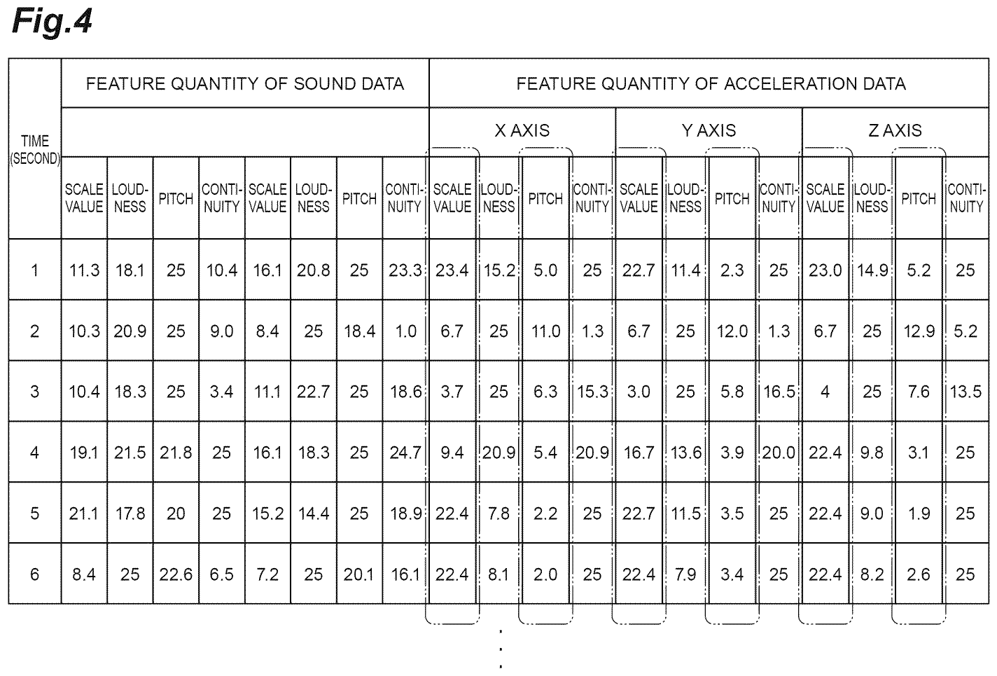

First, a data processing method for sound data will be described. For example, assuming that the sampling frequency of sound data is 16 kHz, the first signal acquisition unit 40 acquires sound data of the frequency. The data processing unit 42 extracts three feature quantities based on different viewpoints by using sound data for each second. As a first feature quantity, the data processing unit 42 calculates a sonogram using the Bark scale (FIG. 3A: time on the horizontal axis, Bark scale on the vertical axis), which is a feature quantity based on the viewpoint of the loudness of sound. As a second feature quantity, the data processing unit 42 calculates a spectrogram (FIG. 3B: time on the horizontal axis, frequency of the sound on the vertical axis), which is a feature quantity based on the viewpoint of the pitch of sound. As a third feature quantity, the data processing unit 42 calculates a chromagram (FIG. 3C: the amount of change over time on the horizontal axis, musical scale on the vertical axis), which is a feature quantity based on the viewpoint of the continuity of sound. As a result, for example, values shown in the items of “loudness”, “pitch”, and “continuity” of the “feature quantity of sound data” in FIG. 4 are obtained in time series (every second). In addition, FIG. 4 shows an example of converted time-series data. As for the “feature quantity of sound data”, the pitch of sound can be calculated from the chromagram (FIG. 3C), and the continuity of sound can be calculated from the spectrogram (FIG. 3B). There is one type of “loudness”. Therefore, two data sets of “scale value”, “loudness”, “pitch”, and “continuity” are obtained for the “feature quantity of sound data”.

The data processing unit 42 extracts three feature quantities based on different viewpoints by using acceleration data for each second. The data processing unit 42 calculates three feature quantities of “loudness,” “pitch”, and “continuity” by performing calculations similar to those for the sound data. As a result, for example, values shown in the items of “loudness”, “pitch”, and “continuity” of the “feature quantity of acceleration data” in FIG. 4 are obtained in time series (every second) for each of the X axis, Y axis, and Z axis.

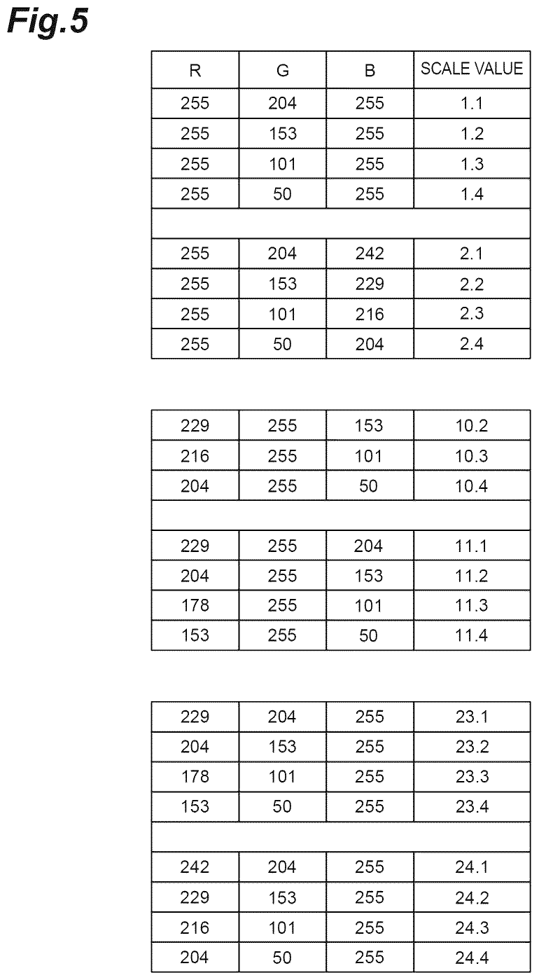

The data processing unit 42 calculates a scale value based on the three feature quantities of each of the sound data and the acceleration data. The scale value is a value calculated by using a color scale conversion table prepared in advance and stored in the storage unit 44. As shown in FIG. 5, the color scale conversion table is a table for determining one color from three color elements of R, G, and B, and one scale value can be determined by applying the values of R, G, and B.

In addition, when there is no combination of R, G, and B that completely matches the color scale conversion table, the data processing unit 42 calculates a scale value by using close values. In addition, the maximum values of R, G, and B shown in FIG. 5 are 255, while the maximum values of “loudness”, “pitch”, and “continuity” shown in FIG. 4 are 25. Therefore, the data processing unit 42 calculates the scale value by applying “loudness”, “pitch”, and “continuity” to the color scale conversion table after adjusting the scale of each value. Therefore, as shown in FIG. 4, the data processing unit 42 calculates a value shown in “scale value” from the values of “loudness”, “pitch”, and “continuity” at each time of the “feature quantity of sound data”. In addition, as shown in FIG. 4, the data processing unit 42 calculates a value shown in “scale value” from the values of “loudness”, “pitch”, and “continuity” at each time of the “X axis”, “Y axis”, and “Z axis” of the “feature quantity of acceleration data”.

The state estimation unit 43 estimates the state of the forklift 50 by distinguishing the results of data processing by the data processing unit 42. The state estimation unit 43 estimates the cargo handling state of the forklift 50. The state estimation unit 43 estimates the state of the forklift 50 by clustering the feature quantity extraction results of the data processing unit 42.

For sound data, the state estimation unit 43 estimates the state of the forklift 50 by picking up items from the “feature quantity of sound data” and the “feature quantity of acceleration data” shown in FIG. 4 and clustering (distinguishing) the tendencies of the combination of feature quantities picked up. For the “feature quantity of sound data”, the state estimation unit 43 picks up all the items (that is, values of eight items) of “scale value”, “loudness”, “pitch”, and “continuity”. On the other hand, as a result of intensive research, for acceleration data, the present inventors have found that the estimation accuracy is improved if, as items other than the “scale value”, the items of “loudness” and “continuity” are not included in clustering and only the item “pitch” is included in clustering. Therefore, for the “feature quantity of acceleration data”, the state estimation unit 43 picks up the items surrounded by the virtual lines in FIG. 4, that is, the items of “scale value” and “pitch” on the “X axis”, “Y axis”, and “Z axis”.

Here, the state estimation unit 43 estimates the state of the forklift 50 at t seconds by acquiring the tendency of the combination of feature quantities picked up at a certain time (t seconds) and comparing the tendency with a state transition model prepared in advance. In the state transition model, the state of the forklift 50 is divided into a plurality of categories, and the tendency of the combination of feature quantities in each state is set. The state transition model is obtained by actually driving the forklift 50 at a test site or the like and acquiring the tendencies of the combination of feature quantities based on the acquired time-series data and clustering the tendencies. The obtained state transition model is stored in the storage unit 44. In addition, classes are configured in a state in which there is a similarity between the operation of the forklift 50 and its operation sound. For example, “a class in which a forklift is raised to start work” and “a class in which an object is placed on a lift and dragged” can be mentioned. As the state, “a state in which a cargo handling operation is being normally performed”, “a state in which an object to be handled is interfering”, and the like are acquired.

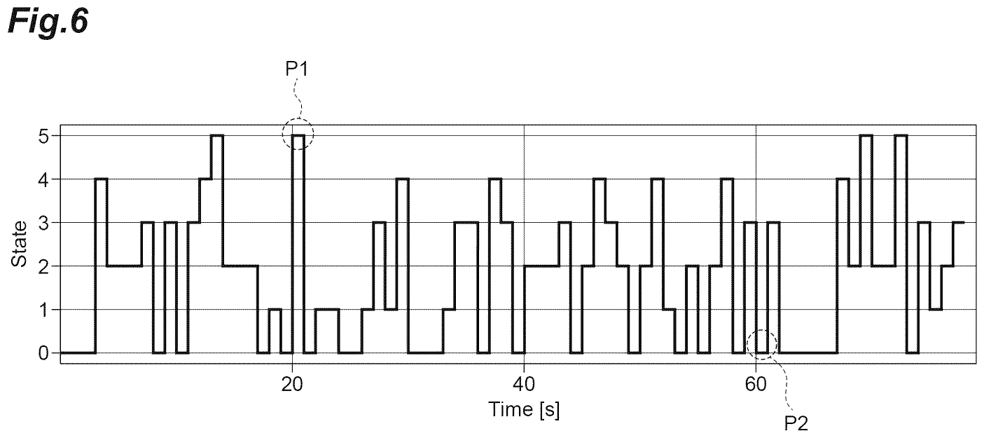

In an example shown in FIG. 6, the state of the forklift 50 is classified into six states of “0” to “5”. In the actual driving of the forklift 50, the state estimation unit 43 determines to which state of “0” to “5” the tendency belongs by acquiring the tendency of the combination of feature quantities at a certain time (t seconds) and comparing the acquired tendency with the state transition model. Then, the state estimation unit 43 estimates that the forklift 50 is in the determined state at t seconds. In FIG. 6, the state estimation unit 43 estimates that the forklift 50 is in the state of “5” at 20 seconds (see P1 in FIG. 6). The state estimation unit 43 estimates that the forklift 50 is in the state of “0” at 60 seconds (see P2 in FIG. 6).

The state estimation unit 43 effectively uses the obtained estimation result for the driving of the forklift 50. For example, when the forklift 50 is automatically driven, the estimation result can be fed back for the automatic control of the forklift 50. When the forklift 50 is manned, the estimation result may be output to the driver. Such an estimation result can be effectively used, for example, for driving, particularly for risk avoidance driving during work. In addition, when a worker drives the forklift 50, it is possible to check whether or not cargo handling is normal even in a state in which the worker cannot visually check due to work at a high lifting height or depth of shelf.

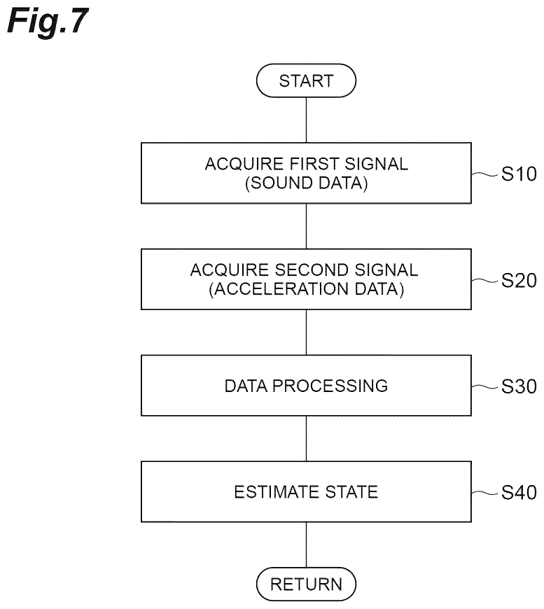

Next, details of control by the control device 100 will be described with reference to FIG. 7. FIG. 7 is a flowchart showing the details of control by the control device 100. This control processing is performed by a computer system executing a control program P (see FIG. 2) stored in the storage unit 44.

First, the first signal acquisition unit 40 of the control device 100 acquires sound data as a first signal (step S10: first signal acquisition step). Then, the second signal acquisition unit 41 acquires acceleration data as a second signal (step S20: second signal acquisition step). Then, the data processing unit 42 performs data processing based on the time-series data of the first signal and the second signal (step S30: data processing step). Then, the state estimation unit 43 estimates the state of the forklift 50 by distinguishing the results of the data processing (step S40: state estimation step). As described above, the control processing shown in FIG. 7 ends, and the processing is repeated from step S10.

Next, the functions and effects of the control device 100 of the forklift 50, the forklift 50, and the control program according to the present embodiment will be described.

Sounds and vibrations generated during the operation and work of the industrial vehicle are useful as signals for grasping the state including abnormalities or the operating situation. However, at a typical work site, there are environmental sounds generated in the surroundings in addition to the sounds generated by the operation of the industrial vehicle. Therefore, first of all, it is necessary to separate the sounds related to the operation of the industrial vehicle from the environmental sounds. However, it is not possible to specify the position of the environmental sound in advance. For example, when similar work is being performed or a similar device is operating in the surroundings, there may not be a clear difference in the characteristics of the acquired signal between sounds related to the operation of the industrial vehicle and environmental sounds. For this reason, it is difficult for a control device that handles only the signal of sound data to distinguish between sounds related to its own operation and environmental sounds. As for vibration, similarly to sound, there may be cases where there is no clear difference in the characteristics of the vibration signal even if the operating situation/state changes, such as a case where the operating axes are the same. For this reason, it is difficult to estimate the operating situation/state from the acceleration signal alone.

As a solution to the above problem, it is conceivable that the accuracy of estimating the operating situation/state and separating the sound generated from the industrial vehicle from the environmental sounds can be improved by combining sound and vibration signals. In order for this solution to work, it is necessary to establish a method to combine sound signals and acceleration signals acquired by different sensors as time-series information. In addition, as a method of estimating the state by using the sound or vibration or distinguishing the sound or vibration from the environmental sounds, there is a method using machine learning. When using machine learning, there is a problem that a large amount of learning data is required and a large amount of learning data should be prepared each time the environment in which the industrial vehicle is operated changes. Therefore, a method that does not use machine learning is required to solve the above problem.

In order to solve the above problem, the industrial vehicle control device 100 according to the present embodiment acquires the first signal and the second signal, so that it is possible to accurately estimate the state of the industrial vehicle by using a plurality of signals rather than a single signal. Here, the data processing unit 42 performs data processing based on the time-series data of the first signal and the second signal. Therefore, the data processing unit 42 can perform data processing based on the time-series data of the first signal and the second signal so as to be suitable for estimating the state of the industrial vehicle. As a result, the state estimation unit 43 can accurately estimate the state of the industrial vehicle by distinguishing the results of the data processing adjusted so that the state can be easily estimated as described above. As described above, it is possible to improve the accuracy of estimating the state of the industrial vehicle.

The first signal acquisition unit 40 may acquire a first signal indicating the surrounding environment of the industrial vehicle, and the second signal acquisition unit 41 may acquire a second signal indicating the state of the industrial vehicle itself. In this case, the state estimation unit 43 can accurately estimate the state of the industrial vehicle by considering two aspects of the surrounding environment of the industrial vehicle and the state of the industrial vehicle itself.

The first signal acquisition unit 40 may acquire sound data from the sound sensor 34 as a first signal, the second signal acquisition unit 41 may acquire acceleration data from the acceleration sensor 31 provided in the cargo handling unit of the industrial vehicle as a second signal, and the state estimation unit 43 may estimate the cargo handling state of the industrial vehicle. In this case, the state estimation unit 43 can accurately estimate the state of the industrial vehicle by considering the sounds generated in the surroundings due to the operation and the like of the industrial vehicle and the acceleration due to the operation of the fork 25 of the cargo handling unit or the traveling of the industrial vehicle.

The data processing unit 42 may acquire time-series data of sound data as a first signal and acceleration data as a second signal and extract a plurality of feature quantities based on different viewpoints from the time-series data at predetermined time intervals, and the state estimation unit 43 may estimate the state by clustering the feature quantity extraction results of the data processing unit 42. In this case, the data processing unit 42 can extract a plurality of feature quantities at predetermined time intervals from data having different properties, such as sound data and acceleration data, so that the state of the industrial vehicle can be easily estimated. Then, the state estimation unit 43 can cluster the extraction results into categories indicating a plurality of states of the industrial vehicle based on the tendency of the extracted feature quantities. Therefore, the state estimation unit 43 can accurately estimate the state of the industrial vehicle.

The industrial vehicle according to the present embodiment includes the industrial vehicle control device 100 described above. This industrial vehicle can obtain the same functions and effects as those of the control device described above.

An industrial vehicle control program according to the present embodiment is an industrial vehicle control program for controlling an industrial vehicle, and causes a computer system to execute: a first signal acquisition step S10 for acquiring a first signal; a second signal acquisition step S20 for acquiring a second signal; a data processing step S30 for performing data processing based on time-series data of the first signal and the second signal; and a state estimation step S40 for estimating a state of the industrial vehicle by distinguishing results of the data processing.

This industrial vehicle control program can obtain the same functions and effects as those of the control device described above.

The present disclosure is not limited to the embodiment described above.

For example, in the above-described embodiment, a reach-type forklift is exemplified as an industrial vehicle, but various forklifts such as a counterbalance-type forklift may be adopted. In addition, when the counterbalance-type forklift is adopted, the detection of a reach operation may be omitted. In addition, the travel driving system may include a travel motor or may include an engine.

[Form 1]

An industrial vehicle control device for controlling an industrial vehicle, including:
a first signal acquisition unit that acquires a first signal;
a second signal acquisition unit that acquires a second signal;
a data processing unit that performs data processing based on time-series data of the first signal and the second signal; and
a state estimation unit that estimates a state of the industrial vehicle by distinguishing results of the data processing.

[Form 2]

The industrial vehicle control device according to Form 1,
wherein the first signal acquisition unit acquires the first signal indicating a surrounding environment of the industrial vehicle, and
the second signal acquisition unit acquires the second signal indicating a state of the industrial vehicle itself.

[Form 3]

The industrial vehicle control device according to Form 2,
wherein the first signal acquisition unit acquires sound data from a sound sensor as the first signal,
the second signal acquisition unit acquires acceleration data from an acceleration sensor provided in a cargo handling unit of the industrial vehicle as the second signal, and
the state estimation unit estimates a cargo handling state of the industrial vehicle.

[Form 4]

The industrial vehicle control device according to any one of Forms 1 to 3,
wherein the data processing unit acquires the time-series data of sound data as the first signal and acceleration data as the second signal and extracts a plurality of feature quantities based on different viewpoints from the time-series data at predetermined time intervals, and
the state estimation unit estimates the state by clustering extraction results of the feature quantities of the data processing unit.

[Form 5]

An industrial vehicle including the industrial vehicle control device according to any one of Forms 1 to 4.

[Form 6]

An industrial vehicle control program for controlling an industrial vehicle, the program causing a computer system to execute:
a first signal acquisition step for acquiring a first signal;
a second signal acquisition step for acquiring a second signal;
a data processing step for performing data processing based on time-series data of the first signal and the second signal; and
a state estimation step for estimating a state of the industrial vehicle by distinguishing results of the data processing.

### REFERENCE SIGNS LIST

2: vehicle, 40: first signal acquisition unit, 41: second signal acquisition unit, 42: data processing unit, 43: state estimation unit, 50: forklift (industrial vehicle), 100: control device.

What is claimed is:

1. An industrial vehicle control device for controlling an industrial vehicle, comprising:
a first signal acquisition unit that acquires a first signal;
a second signal acquisition unit that acquires a second signal;
a data processing unit that performs data processing based on time-series data of the first signal and the second signal; and
a state estimation unit that estimates a state of the industrial vehicle by distinguishing results of the data processing.

2. The industrial vehicle control device according to claim 1,
wherein the first signal acquisition unit acquires the first signal indicating a surrounding environment of the industrial vehicle, and
the second signal acquisition unit acquires the second signal indicating a state of the industrial vehicle itself.

3. The industrial vehicle control device according to claim 2,
wherein the first signal acquisition unit acquires sound data from a sound sensor as the first signal,
the second signal acquisition unit acquires acceleration data from an acceleration sensor provided in a cargo handling unit of the industrial vehicle as the second signal, and
the state estimation unit estimates a cargo handling state of the industrial vehicle.

4. The industrial vehicle control device according to claim 1,
wherein the data processing unit acquires the time-series data of sound data as the first signal and acceleration data as the second signal and extracts a plurality of feature quantities based on different viewpoints from the time-series data at predetermined time intervals, and
the state estimation unit estimates the state by clustering extraction results of the feature quantities of the data processing unit.

5. An industrial vehicle, comprising:
the industrial vehicle control device according to claim 1.

6. An industrial vehicle control program for controlling an industrial vehicle, the program causing a computer system to execute:
a first signal acquisition step for acquiring a first signal;
a second signal acquisition step for acquiring a second signal;
a data processing step for performing data processing based on time-series data of the first signal and the second signal; and
a state estimation step for estimating a state of the industrial vehicle by distinguishing results of the data processing.
